(19) United States
(12) Patent Application Publication
(10) Pub. No.: US 2006/0204658 A1
(43) Pub. Date: Sep. 14, 2006

(54) Method and an apparatus for applying an adhesive onto a flat building element

(75) Inventor: Dagfinn Andersen, Kristiansand (NO)

Correspondence Address: RODMAN RODMAN, 7 SOUTH BROADWAY, WHITE PLAINS, NY, 10601, US

(73) Assignee: Oyvind LINNEBO, Horvag (NO)

(21) Appl. No.: 11/077,049

(22) Filed: Mar. 10, 2005

(51) Int. Cl. B05D 5/10

(52) U.S. Cl. 427/207.1; 156/578

(57) ABSTRACT

An apparatus for applying an adhesive onto one face of a flat building element (17) to provide for subsequent adhesive assisted attachment of the element to a support after the element is removed from the apparatus. The apparatus comprises a holder (11) to hold a plurality of building elements in a stacked supply (16); a jig (2,3) for locating thereat in a stationary fashion said flat building element (17) one at a time, said flat building element (17) retrievable from said stacked supply (16) as an uppermost element of the supply, and said jig having an associated platform (1) to support said retrieved building element with its said one face facing upwards; a carriage (4) with an associated adhesive supply (7,8, 9), the carriage (4) being configured in a controllable manner to be movable along the jig and thereby along said retrieved building element (17) when located on said platform from a first end region of the building element to a second end region thereof; a means (18) for controllably supplying pressurized adhesive onto said one face of the building element from the adhesive supply (7,8, 9) via an adhesive applicator device while the carriage (4) is caused to move along the building element over its full length, and adjustment means (12, 13) being operative with said holder for stepwise or step-free adjustment of an upper level of the supply of building elements in order to let an uppermost element in the stacked supply (16) of elements assume a predetermined level close to or at a level of said platform (1). The invention also provides a method in order to operate the apparatus.

The present invention relates to a method and an apparatus for applying an adhesive onto one face of a flat building element, e.g. a rear face of a parquet element or a parquet block.

It is previously known to apply an adhesive manually directly onto a rear face of a parquet element using a brush and an adhesive distributor, which is a cumbersome and quite messy operation, rendering possibility of spilling adhesive and causing the adhesive to be exposed to air for a too long period of time. This is in particular for long parquet elements a substantial problem in view of the fact that each element after application thereon of adhesive must be placed on the flooring support and mounted in right position before adhesive can be applied to a next parquet element.

Further, a adhesive applicator apparatus is known from PCT-publication WO99/56888 disclosing a stationary adhesive applicator, each parquet element to be pushed past the applicator. Another adhesive applicator apparatus is known from Swedish patent 503121, said apparatus having a movable adhesive applicator for applying adhesive to a groove located along a longitudinal edge of a flooring element, the application of adhesive being made to the lowermost element in a stack of elements.

It is therefore an object of the invention to provide for a method which more efficiently enables application of adhesive onto a building element, such as e.g. a parquet element or panel without having to push the element past an applicator with inherent risk of spillage of adhesive, cumbersome movement of elements from a supply, and to provide for an apparatus which has a longitudinal extension which is only slightly longer than a longest element onto which adhesive is to be applied and with a width substantially less than the prior apparatus of WO99/56888, and where movement of an element from a stack of elements to a position for application of adhesive can be made swifter, with less movements of the element, safer and with less physical strain on an operator of the apparatus.

The present invention therefore provides for a method for applying an adhesive onto one face of flat building element to provide for subsequent adhesive assisted attachment of the element to a support, the method comprising one or more times carrying out the steps of:

retrieving from a stacked supply of building elements such flat building element and which at time of retrieval is located uppermost in the stacked supply, the uppermost level of the supply being adjusted upon each retrieval of a building element, so that an uppermost element in said stacked supply of elements always will be at specific level,

locating in a stationary fashion a retrieved building element in a jig on a jig related platform with its said one face facing upwards to allow for application of adhesive thereon,

moving a carriage with an associated adhesive supply along the retrieved building element from one end thereof to its other end while the building element is stationary held by the jig, and thereby applying pressurized adhesive from said adhesive supply in a predetermined pattern onto said one face the building element over its full length, and

removing the building element with applied adhesive thereon from the jig.

Suitably, said building element is a parquet floor element or parquet block, and said support is a flooring base.

Furthermore, the invention provides for an apparatus for applying an adhesive onto one face of a flat building element to provide for subsequent adhesive assisted attachment of the element to a support after the element is removed from the apparatus. In a preferred embodiment, the apparatus comprises:

a holder to hold a plurality of building elements in a stacked supply,

a jig for locating thereat in a stationary fashion said flat building element one at a time, said flat building element retrievable from said stacked supply as an uppermost element of the supply, and said jig having an associated platform to support said retrieved building element with its said one face facing upwards,

a carriage with an associated adhesive supply, the carriage being configured in a controllable manner to be movable along the jig and thereby along said retrieved building element when located on said platform from a first end region of the building element to a second end region thereof,

a means for controllably supplying pressurized adhesive onto said one face of the building element from the adhesive supply via an adhesive applicator device while the carriage is caused to move along the building element over its full length, and

adjustment means being operative with said holder for stepwise or step-free adjustment of an uppermost level of the supply of building elements in order to let an uppermost element in the stacked supply of elements assume a predetermined level close to or at a level of said platform.

Suitably, said movement of the carriage is a continuous and steady movement along said full length.

In a preferred embodiment, the apparatus is useful for handling a building element in the form of a parquet floor element or a parquet block. Then, said support is a flooring base.

The carriage is suitably motor driven via a belt drive or via a rotary screw which extends substantially along a full length of said platform.

The carriage is suitably configured to provide application of adhesive onto said one face in a predetermined pattern, and said one face is a rear face of the building element.

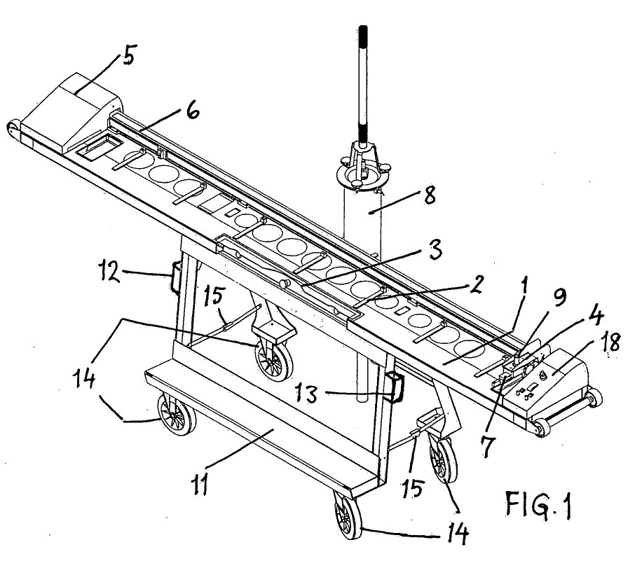

FIG. 1 shows the apparatus, according to the invention, without building elements located thereon.

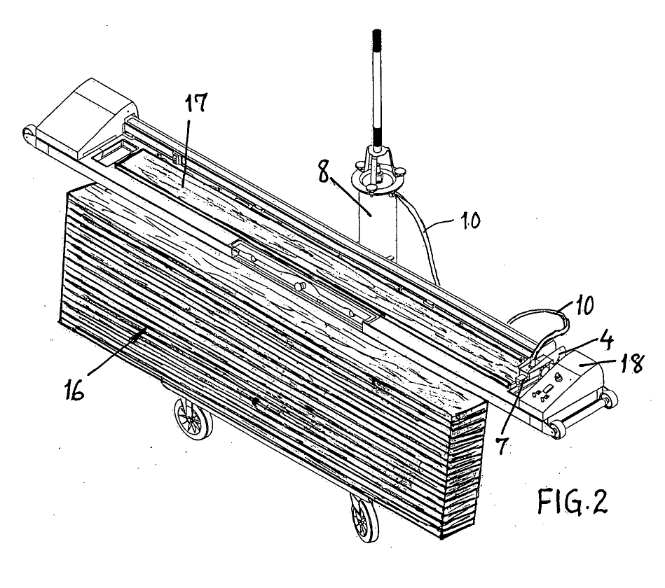

FIG. 2 shows the apparatus of FIG. 1 with building elements located thereon.

FIG. 1 shows the apparatus with a platform 1, jig elements 2 and a tensioning piece 3 to co-act with the jig elements 2. A carriage 4 is provided for movement along the platform 1 and driven by a motor unit 5, e.g. a low voltage electric motor, via a belt drive or drive screw, both schematically denoted by reference numeral 6. The carriage 4 is equipped with an adhesive applicator mouth piece having nozzles (not shown) and indicated generally by reference numeral 7.

An adhesive pump 8 is suitably provided to deliver pressurized adhesive to the applicator mouth piece 7 located on the carriage via an inlet 9 on the mouthpiece 7. A hose connection between the inlet 9 and the pump 8 is not shown on FIG. 1 for sake of clarity, but is indicated on FIG. 2 by reference numeral 10.

A holder 11 is shown on FIG. 1 capable of holding a plurality of building elements in a stacked supply thereof. The holder 11 is configured to be stepwise or step-free movable. So that the upper level of the supply of building elements after each retrieval of a building element 17 from a top of the stacked supply 16 of elements and location of the element 17 on the platform 1 lifts the supply of building elements, so that the uppermost element in the stacked supply thereby can assume a predetermined level, as indicated on FIG. 2. In order to provide for such lifting of the building elements there may be used a pair of motors 12, 13 driving a screw device (not shown) to adjust the upper level of the stacked supply and thereby the level of the holder 11. The apparatus has preferably lockable wheels 14 and articulated arms 15 to make the chassis as narrow as possible for storage purposes.

On FIG. 2 is shown how the holder 11 can be loaded with a stack 16 of building elements, such as e.g. parquet elements, and where it has been shown a building element 17 with its rear face facing upwards and located in the jig 2, 3 for application of adhesive by means of the carriage 4 and the adhesive applicator mouthpiece 7 attached thereto.

A control panel 18 is provided to enable an operator to conveniently control the operations which the carriage 4 is to make for application of adhesive onto a rear face of a building element.

1. A method for applying an adhesive onto one face of flat building element to provide for subsequent adhesive assisted attachment of the element to a support, the method comprising one or more times carrying out the steps of:
retrieving from a stacked supply of building elements such flat building element and which at time of retrieval is located uppermost in the stacked supply, the uppermost level of the supply being adjusted upon each retrieval of a building element, so that an uppermost element in said stacked supply of elements always will be at specific level,
locating in a stationary fashion a retrieved building element in a jig on a jig related platform with its said one face facing upwards to allow for application of adhesive thereon,
moving a carriage with an associated adhesive supply along the retrieved building element from one end thereof to its other end while the building element is stationary held by the jig, and thereby applying pressurized adhesive from said adhesive supply in a predetermined pattern onto said one face the building element over its full length, and
removing the building element with applied adhesive thereon from the jig.

2. The method according to claim 1, wherein said building element is a parquet floor element or parquet block.

3. The method according to claim 1, wherein said support is a flooring base.

4. An apparatus for applying an adhesive onto one face of a flat building element to provide for subsequent adhesive assisted attachment of the element to a support after the element is removed from the apparatus, the apparatus comprising
a holder to hold a plurality of building elements in a stacked supply,
a jig for locating thereat in a stationary fashion said flat building element one at a time, said flat building element retrievable from said stacked supply as an uppermost element of the supply, and said jig having an associated platform to support said retrieved building element with its said one face facing upwards,
a carriage with an associated adhesive supply, the carriage being configured in a controllable manner to be movable along the jig and thereby along said retrieved building element when located on said platform from a first end region of the building element to a second end region thereof,
a means for controllably supplying pressurized adhesive onto said one face of the building element from the adhesive supply via an adhesive applicator device while the carriage is caused to move along the building element over its full length, and
adjustment means being operative with said holder for stepwise or step-free adjustment of an uppermost level of the supply of building elements in order to let an uppermost element in the stacked supply of elements assume a predetermined level close to or at a level of said platform.

5. The apparatus of claim 4, wherein said movement of the carriage is a continuous and steady movement along said full length.

6. The apparatus of claim 4, wherein said building element is a parquet floor element or parquet block.

7. The apparatus according to claim 4, wherein said support is flooring base.

8. The apparatus according to claim 4, wherein said carriage is motor driven via a belt drive.

9. The apparatus according to claim 4, wherein said carriage is motor driven via a rotary screw which extends substantially along a full length of said platform.

10. The apparatus according to claim 4, wherein said carriage is configured to provide application of adhesive onto said one face in a predetermined pattern.

11. The apparatus according to claim 4 wherein said one face is a rear face of the building element.
